(19) United States
(12) Patent Application Publication
(10) Pub. No.: US 2009/0155427 A1
(43) Pub. Date: Jun. 18, 2009

(54) ALGINATE CROSSLINK COATING OF AN EDIBLE ALCOHOL

(75) Inventors: Patrick J. Jobe, Becker, MN (US); Gary L. Morris, Terre Haute, IN (US); Anthony J. Sberna, Nashville, TN (US)

Correspondence Address: ICE MILLER LLP, ONE AMERICAN SQUARE, SUITE 3100, INDIANAPOLIS, IN, 46282-0200, US

(73) Assignee: Clabber Girl Corporation, Terre Haute, IN (US)

(21) Appl. No.: 11/955,361

(22) Filed: Dec. 12, 2007

(51) Int. Cl. C12G 3/00

(52) U.S. Cl. 426/96; 426/103; 426/592

(57) ABSTRACT

An encapsulated alcohol bead, and methods for producing and using the same, comprising a droplet of alcohol coated by a water-insoluble, alginate-based gel. The alginate-based coating comprises a plurality of pores having a diameter sufficient to allow the alcohol contained within each encapsulated alcohol bead to leach therethrough when the encapsulated alcohol bead is placed within a solution. Various dry mix products may include the encapsulated alcohol beads, such that the resultant products produced therefrom do not require a user to independently add alcohol thereto, and contain a sufficient amount of alcohol and/or alcohol flavor.

This application is a continuation-in-part of Ser. No. 60/874,155, a U.S. provisional application filed on Dec. 12, 2006.

### FIELD

The field generally relates to an edible, encapsulated liquid, a method of producing such edible, encapsulated liquid, and the products produced from such edible, encapsulated liquid.

### BACKGROUND

Over the decades, the baking industry has seen movement away from baking and cooking from “scratch” due to the time requirements associated therewith. Instead, the market trends have shifted toward “convenience” home baked products, such as mixes, doughs and fillings that can be quickly assembled and prepared to produce a fresh baked good. Such mixes in the dry form typically comprise flour, sugar, shortening, and other ingredients including emulsifiers (generally incorporated into the shortening), leavening, flavors, and additives. In addition, dried eggs and dehydrated nonfat milk solids may also be incorporated or alternatively added in the liquid state by the consumer.

To prepare a conventional baking mix, the dry ingredients are combined in the proper proportions and mixed thoroughly to achieve a free-flowing, granular mixture. The amounts, types and selection of the particular components of the dry mix vary depending on the type and flavor of the mix desired. Because all of the ingredients in the mix are dry, such mixes exhibit acceptable shelf lives. Further, as the dry ingredients are pre-measured and pre-blended, the consumer is ensured that the dry ingredients are properly measured and present in a homogeneous mixture, thereby increasing the probability that the end product will exhibit acceptable volume, texture and mouth-feel.

To prepare dry baking mixes for baking, liquid ingredients (i.e. water, milk, and eggs) must be added to the blend of dry ingredients. Such liquid ingredients may not be stored with the dry mix of ingredients because, once mixed, the wet and dry ingredients react with one another. Further, the addition of the wet ingredients increases the rate at which the mixture will spoil.

One common liquid ingredient is alcohol. Alcohols intended for human consumption (e.g., liquors, beer, wine, etc), specifically alcoholic beverages, have long been used in the cooking and baking industries as additives. Like other liquid ingredients, such edible alcohols cannot be premixed and packaged with the blend of dry ingredients because edible alcohol is in a liquid form. As such, alcohol conventionally must be incorporated with the dry mix when the other prescribed liquid ingredients are added.

Once the liquid ingredients are added to the dry mix of ingredients, the combination is blended to form a homogeneous mixture and to incorporate air. The resulting batter or dough is then baked. Accordingly, conventional baking mixes offer consumers the convenience of being able to prepare a baked good with substantially less preparation than if the user independently measured and combined all of the prescribed ingredients.

The quality of baked goods produced from a baking mix is typically high. One contributing factor to the high quality seen in such baked goods is the fact that the dry ingredients are correctly measured and thoroughly mixed. Traditionally, the volume, texture and mouth-feel qualities of baked products are dependent upon the interaction of the various ingredients during the above-described mixing operation. One quality in particular the volume of the baked product, is maximized when the dry ingredients are thoroughly and evenly dispersed throughout the added liquid(s). Because each ingredient in a baking mix is pre-measured and the dry mixture is pre-blended, conventional baking, mixes facilitate the even dispersion of the dry ingredients with one another such that it is easier to achieve an even and thorough mixture once the liquid ingredients are added. Accordingly, it is beneficial to include as many ingredients as possible in the pre-blended dry mix, as doing so ensures the most thorough mixture possible, decreases the burden on the consumer to purchase and measure various ingredients, and decreases the likelihood of consumer error in the preparation process.

### SUMMARY

In one embodiment, an encapsulated alcohol bead comprises a droplet of alcohol containing beverage coated by a water-insoluble, alginate-based gel. The alginate-based coating of the encapsulated alcohol bead comprises a plurality of pores, which allow alcohol molecules to traverse therethrough when the encapsulated alcohol bead is added to a hypotonic solution.

In an additional embodiment, a method of producing the above-identified encapsulated alcohol beads is disclosed. Specially, the method comprises preparing a first solution comprising an alginate dissolved in an alcohol containing beverage and separately preparing a second solution comprising a multivalent salt dissolved in an alcohol containing beverage. The first solution is dropped or sprayed into the second solution such that a plurality of encapsulated beads are formed that each contain a volume of alcohol containing beverage within an alginate-based coating. Once the desired amount of beads are formed, the encapsulated alcohol beads may be filtered from the second solution using a sieve or other filtering mechanism. The resultant encapsulated alcohol beads are thereafter allowed to dry and exhibit free-flowing, properties.

In one application of the encapsulated alcohol beads, an amount of the encapsulated alcohol beads are added to at least two dry mix ingredients. The resultant edible composition may comprise a dry mix of ingredients for use in baking. Alternatively, the edible composition may comprise a dry mix of ingredients for preparing an alcoholic beverage or a gelatin product. The encapsulated alcohol beads may be mixed with the dry ingredients and stored therewith for an extended period of time such that a user does not need to add any liquid alcoholic beverage to the dry mix during preparation of the end product.

In preparing the end product, the dry mix of ingredients (containing the encapsulated alcohol beads) is hydrated by adding a hypotonic solution thereto. When the hypotonic solution is added to the dry mix, the alcohol containing beverage within the encapsulated alcohol beads leaches through the porous alginate-based coating and into the solution. Accordingly, an end product is produced containing an amount of edible alcohol and/or alcohol flavoring.

### DETAILED DESCRIPTION

Reference will now be made to various embodiments and specific language will be used to describe the same. It will nevertheless be understood that no limitation of scope is intended by the description of these embodiments. Throughout the specification and claims, percentages and ratios are by weight and temperatures are in degrees Fahrenheit, unless otherwise indicated. Further, it will be understood that all references to an alcohol herein refers to an alcohol intended for human consumption.

In order to achieve an alcohol that may be added to and stored with a dry mix of ingredients for a period of time, the alcohol itself must be in a dry form. A dry form of alcohol may be achieved through the encapsulation technique described herein. In one embodiment, an encapsulated alcohol bead comprising an alginate-based gel coating is formed by dropping an alcohol-based alginate solution into an alcohol-based salt solution. The resultant encapsulated alcohol beads comprise a liquid center made primarily of alcohol, which is contained by an alcohol-based gel coating.

Specifically, the alginate solution comprises an alkali metal alginate dissolved into a first volume of alcohol. The resulting solution comprises between about 0.5% and 5% by weight of the alginate. Concentrations of alginate below about 0.5% are increasingly ineffective in producing defect-free capsules. Similarly) concentrations of alginate above about 5% are often too viscous to allow formation of small beads. In one embodiment, sodium alginate is used as the alginate source for the alginate solution.

The second solution of the method is a salt solution. The salt solution comprises a salt dissolved into a second volume of the alcohol. The salt of the salt solution may comprise any multivalent salt, such as calcium chloride, magnesium chloride, or manganese chloride, and the resulting solution comprises between about 0.5% and 50% by weight of the salt. The alginate solution and salt solutions are prepared independently of each other and may comprise the same or different types of alcohol. It will be appreciated that the alcohol(s) used in preparing the encapsulated alcohol beads may be selected from any alcohol intended for human consumption known in the art, for example, and without limitation, beer, wine, sherry, brandy, liqueurs, port, vodka, gin, whiskey, scotch, cognac, tequila, or rum. Further) the alcohol used to prepare the alginate solution may comprise a different type of alcohol than the alcohol used to prepare the salt solution. In one embodiment, whiskey is used to prepare the alginate solution and gin is used to prepare the salt solution.

Once the alginate solution and salt solution are prepared, encapsulated alcohol beads are formed. Shape retaining, heat-stable, water-insoluble gel beads are prepared by dropping or spraying droplets of the alginate solution into the salt solution. The formation of discrete droplets may be achieved by any spraying or dropping method known in the art. In one embodiment, the alginate solution is dropped into the salt solution in a drop-by-drop fashion. In an alternative embodiment, the alginate solution is poured onto a rotating disk such that substantially spherical droplets are expelled and collected in the salt solution. In yet another embodiment, the alginate solution is extruded or pumped through an orifice or a needle at a rate slow enough to prevent the formation of a stream, or by building a stream of the alginate solution and breaking up the stream by means of a resonance technique known in the art (e.g., vibration or pulsation). It will be appreciated that regardless of which method is used to drop the droplets of alginate solution into the salt solution, the dropping point of the alginate solution, the calibration of the nozzle, and the concentration of both liquids are regulated to achieve satisfactory results.

As the droplets enter the salt solution, the alkali metal counter-ions of the alginate are exchanged by the multivalent cations, resulting in the instantaneous gelation of the droplets through the formation of multiple salt bridges between the alginate molecules. The salt bridge formation occurs continuously for as long as the droplets are emerged in the salt solution, thereby creating an inwardly moving gelling zone. Accordingly, the final thickness of the alginate-based coating encompassing the beads is dependent upon the length of time the droplets are allowed to bathe in the salt solution, which may be for up to about 24 hours.

If the bead is removed from the salt solution prior to gelling all of the way through, an amount of alcohol from the alginate solution is encapsulated within the water-insoluble alginate-based gel coating. Accordingly, a plurality of encapsulated alcohol beads, each about 0.5 microns to about 10 millimeters in diameter, are formed and suspended in the surplus salt solution. In one embodiment, the droplets are allowed to bathe in the salt solution for about 1 minute and the encapsulated alcohol beads formed each comprise a diameter of less than about 1 millimeter.

The alginate-based coating formed around the drops of alcohol comprises microscopic pores, and thus resembles a mesh-like configuration. The relatively large pore size of the alginate-based coating restricts the capability of the alginate gel to act as an insurmountable barrier for smaller molecules. Accordingly, the alcohol contained within the coating is capable of traversing through the gel coating and out into the surrounding salt solution. However, because the salt solution is an alcohol based solution and the system is near equilibrium, little osmotic pressure is exerted upon the alcohol contained within the beads. Accordingly, the salt solution is nearly isotonic with respect to the alcohol contained within the beads and therefore there is little movement of alcohol into or out of the bead.

Once the desired amount of encapsulated alcohol beads is formed, the encapsulated alcohol beads may be isolated from the suspension by filtration or centrifugation, thereby yielding moist beads. In one embodiment, the mixture is filtered through a sieve or other straining device to separate the encapsulated alcohol beads from the remainder of the salt solution. Thereafter, the encapsulated alcohol beads are not dried, but simply allowed to rest on an absorbent surface for a period of time to remove any surface residue therefrom. Drying techniques may prove ineffective due to the large pore sizes of the alginate-based gel coating and the propensity of alcohol to evaporate. By allowing the beads to rest on an absorbent surface, the encapsulated alcohol does not evaporate from the center of the beads and is preserved therein. Further, because this embodiment does not use oil to facilitate bead formation, the resultant encapsulated alcohol beads are free of any residual oil that is detrimental to achieving a free-flowing mixture when the encapsulated alcohol beads are added to a dry mix of ingredients.

Optionally, prior to allowing the encapsulated alcohol beads to rest on an absorbent surface, the beads may be washed in a chilled ion free solution. Specifically, when the encapsulated alcohol beads are formed in the salt solution, it is not uncommon for salt from the salt solution that did not react with the alginate to remain within the encapsulated alcohol bead. Such unreacted salt has the potential of affecting the taste of the encapsulated alcohol beads when used in food products. Accordingly, to prevent this, the encapsulated alcohol beads may be washed in a chilled alcohol solution to allow any unreacted salt to drain out of the encapsulated alcohol beads. In one embodiment, the solution in which the beads are washed comprises the same type of alcohol that is encapsulated within the alginate-based coating of the beads. Once the encapsulated alcohol beads have been washed for the desired amount of time, the encapsulated alcohol beads may be isolated from the suspension by filtration or centrifugation and allowed to dry as previously described.

The encapsulated alcohol beads and the method of producing the same is further illustrated by the following non-limiting example.

### EXAMPLE 1

Sodium alginate (0.5 g) was dissolved in vodka spirits (99 g; 40% alcohol by volume) with stirring to produce a homogeneous aqueous solution. The solution was fed through a pipette in 5 milliliter increments into a solution containing 10 grams of calcium chloride dissolved in 100 grams of vodka spirits (40% alcohol by volume). The flow rate through the pipette was adjusted to prevent the formation of a stream. The alginate-alcohol droplets, upon entering the calcium chloride solution, immediately gelled to yield gelatinized beads containing vodka. After completion of the addition, the beads were isolated by filtration through a No. 20 mesh sieve. The filtered beads were allowed to dry on a paper towel to form a dry, free-flowing product.

Once the encapsulated alcohol beads comprise a dry, free-flowing product, the encapsulated alcohol beads may be used as additives in dry mixes and/or beverages to modify the alcohol content and/or for flavoring purposes. Because the encapsulated alcohol beads are in a dry, free-flowing form, the encapsulated alcohol beads can be added directly to dry mixes and stored therewith for extended periods of time. Further, the encapsulated alcohol beads exhibit a enhanced shelf life due to the high concentration of ethyl alcohol contained therein, which acts to preserve the alginate-based coating and prevents microbial growth.

In one embodiment, the encapsulated alcohol beads are premixed with a baking: dry mix. By mixing the encapsulated alcohol beads with the baking dry mix) the user is not required to add liquid alcohol to the batter when the other liquid ingredients are incorporated. Further, the encapsulated alcohol beads may be thoroughly and evenly mixed with the other dry ingredients, thereby increasing the probability that a superior baked product will be achieved. In one embodiment, the baking dry mix may comprise a mixture of flour, sugar, emulsified shortening, chemical leavening agents, color, flavoring materials, and a plurality of encapsulated alcohol beads. It will be appreciated that any combination of the above ingredients will be sufficient to produce a baked good containing the residual flavor of an alcoholic beverage so long as an adequate amount of flour chemical leavening agents, and encapsulated alcohol beads are contained therein.

The dry mix composition to which the encapsulated alcohol beads are added may comprise any baking mix known in the culinary art. Specifically, the dry mix composition may contain from about 20% to about 60% of flour. The flour(s) useful in this embodiment may be of any conventional type and quality. Further, the dry mix composition may comprise from about 20% to about 70% of sugar. The sugar component of the dry mix may be comprised of sucrose, dextrose, or other nutritive carbohydrate sweetening agents such as corn syrup solids. In addition, it will be appreciated that most commercially available sugars typically contain up to about 4% starch to facilitate the free-flowing properties of the sugar. In one embodiment, at least 50% by weight of the sugar ingredient is finely ground (i.e. has an average particle size of about 50 microns or below). Finely ground sugars aid to the pourability of the dry mixes, particularly when plastic shortenings are used in high levels. In this embodiment, the remainder of the sugar component can be supplied by conventional granulated sugar.

The baking mix composition may further comprise from about 4% to about 26% of a shortening ingredient. In one embodiment, the shortening component comprises about 11% of the dry mix composition. Maintenance of shortening concentrations within the above limits is often important for the dry mix to maintain a free-flowing nature and to provide a baked good having good textural quality. In this embodiment, conventional shortening materials and emulsifiers may comprise the shortening ingredient of the dry baking mix.

The chemical leavening agent of the dry ingredient comprises from about 0.1% to about 4% of the dry mix. Any general chemical leavening agent or system may be employed in the formulation of the dry baking mix. In general, such systems utilize baking soda (e.g., sodium bicarbonate or potassium bicarbonate) and common baking acids. Examples of such baking acids include, but are not limited to, citric acid, lactic acid, acetic acid propionic acid, cream of tartar, monocalcium phosphate monohydrate, fast acting sodium acid pyrophosphate and mixtures thereof.

In addition to any other flavorings or additives that are known in the art, the encapsulated alcohol beads described above are further included in the dry mix. Due to the composition of the encapsulated alcohol beads, the encapsulated alcohol beads easily mix with the other dry ingredients and are storable therewith. As previously noted, due to the alcohol's inherent tendency to prevent microbial growth, the encapsulated alcohol beads exhibit an enhanced shelf life that is acceptable in terms of the retail market.

The dry mixes comprising encapsulated alcohol beads are prepared by blending the essential and optional components together in a conventional manner so as to produce a uniform, free-flowing dry mix. Optionally, the dry mix preparation is thereafter finished in a standard commercial finisher. Finishers are devices for reducing shortening lump size and for more intimately incorporating the shortening into a mix by impact mixing. Once finishing is complete, if necessary, larger sized optional ingredients such as nuts and dried fruits may be blended into the dry mix. The resulting dry mix is then packaged in a conventional manner in conventionally suitable containers which typically hold specific weights of the dry mix.

The various embodiments of the dry mix described above may be conveniently prepared into finished baked products by forming a gently admixed, heterogeneous batter. (While, in the interest of brevity, the description herein refers only to a batter, it will be recognized that the method described herein can be equally applied to a dough mixture. To form the batter, water or other aqueous liquids, oils, eggs or egg whites are added to the dry mix and either beaten by hand or with a mixer. The resultant batter will have about 20% to 40% moisture, about 0 to about 30% oil in addition to the shortening component, and about 0 to about 5% egg solids. When the liquid ingredients are added to the dry mix, the encapsulated alcohol beads are exposed to the aqueous solution. As previously noted, due to the large pores of the alginate-based coating, the alcohol contained within the beads can freely flow therefrom. In this manner, when the liquid ingredients are added to the dry mix containing the encapsulated alcohol beads, the alcohol begins to leach out of the heads and into the batter.

The speed at which the alcohol leaches into the batter will depend on the consistency and composition of the liquids added to the dry mix. For example, if only water is added to the dry mix, the solution surrounding the encapsulated alcohol beads will be hypotonic, thereby subjecting the alcohol within the beads to increased osmotic pressure. This increased osmotic pressure facilitates the leaching of the alcohol within the beads into the solution relatively quickly. However, if only oil is added to the dry mix, the solution surrounding the encapsulated alcohol beads still not promote the movement of the alcohol from within the beads into solution. Accordingly, the leaching of the alcohol from within the beads and into solution will occur more slowly.

Once the liquid ingredients are added to the dry mix and the batter is sufficiently mixed, a suitable quantity of the batter is spooned into a container and heated for a sufficient time. When the batter is heated, the encapsulated alcohol beads contained therein are likewise subjected to increased temperatures. The heating process may include, but is not limited to, cooking, baking, frying, boiling, roasting, and smoking. During the heating process, the ethanol component of any alcohol present within the encapsulated alcohol beads or in the batter itself will evaporate, thereby leaving the essence, or flavor, of the alcohol within the final baked product.

In addition to the alcohol flavoring, the resultant baked product comprises an increased final moisture content. Specifically, because the encapsulated alcohol beads were added in a dry form, the addition of the encapsulated alcohol beads to the batter did not contribute to the liquidity of the batter consistency. However, the addition of the encapsulated alcohol beads increased the overall moisture content of the batter. In this manner, a batter or dough is able to receive an increased amount of moisture without negatively affecting the consistency or viscosity thereof. Accordingly, the final moisture content of the end baked product is higher than if the encapsulated alcohol beads had not been added.

In an alternative embodiment, the encapsulated alcohol beads described herein may be added to a dry mix containing gelatin to produce a gelatin food product containing alcohol. For example, the encapsulated alcohol beads can be added to an instant gelatin product known in the art to produce what are commonly known as gelatin shots.

Specifically, the method of producing a gelatin dry mix containing alcohol comprises preparing a dry blend of instant gelatin product as is known in the art and adding encapsulated alcohol beads thereto. In one embodiment, a dry blend of gelatin, sweetener, and encapsulated alcohol beads in a dry form is prepared. Other optional ingredients, such as food coloring and flavoring, may optionally be added. The dry mixes of alcoholic gelatin products disclosed herein may be prepared by blending the essential and optional components together in a conventional manner so as to produce a uniform, free-flowing dry mix.

Due to the composition of the encapsulated alcohol beads, the encapsulated alcohol beads easily mix with the other dry ingredients and are storable therewith. As previously noted, due to the alcohol's inherent tendency to prevent microbial growth, the encapsulated alcohol beads exhibit an enhanced shelf life that is acceptable in terms of the retail market. The resulting dry mixes are then packaged in a conventional manner in conventionally suitable containers which typically hold specific weights of the dry mix.

The process of preparing the pre-mixed alcoholic gelatin product is performed by methods known in the art. Specifically, the process for preparing the alcoholic gelatin comprises: (1) dissolving the above-described alcoholic gelatin dry mix by heating and mixing the dry mix in a liquid; and (2) cooling the solution to form a gel. In this manner, a user may produce gelatin product containing alcohol by simply adding a liquid.

In yet another embodiment, the encapsulated alcohol beads are used to prepare a prepackaged dry form of alcohol. Specifically, a predetermined number of encapsulated alcohol beads may be added to an alcoholic or nonalcoholic beverage to increase the alcohol content therein. In this embodiment, the encapsulated alcohol beads contain a specific type of alcohol and may be individually packaged such that a user can simply add the contents to a liquid to produce a beverage having a desired alcohol content. It will be appreciated that the encapsulated alcohol beads may be packaged in any quantity, including single serving a packets equivalent to 1 ounce of liquid alcohol, or a shot.

Further, a mixture of encapsulated alcohol beads containing different alcohols may be included in a single packet such that, when the contents of the packet are added to a liquid, the different alcohols released from the beads mix, thereby forming a cocktail comprised of different types of alcohol. For example, one packet may contain a first amount of encapsulated alcohol beads containing vodka, a second amount of encapsulated alcohol beads containing gin, a third amount of encapsulated alcohol beads containing tequila, and a fourth amount of encapsulated alcohol beads containing rum such that, when the packet is added to the desired base liquid, the different alcohols mix together to create a Long Island Iced Tea beverage. It will be appreciated that any number of alcohol combinations may be developed, and that any alcohol capable of being encapsulated by the process disclosed herein may be used in the prepackaged dry form of alcohol.

In another embodiment, the encapsulated alcohol beads may be mixed with a dry form of powdered flavoring and used to adjust the flavor and alcohol content of a beverage. In one embodiment, a mixture comprising powdered flavoring and encapsulated alcohol beads is packaged in convenient single serving packets. Accordingly, a user may customize his or her beverage by selecting a specific flavoring and alcohol combination. For example, one packet may contain an orange based flavoring and an amount of encapsulated tequila formulated to be added to a specific volume of liquid. When the user adds the contents of the packet to a 12 ounce glass of water, for example, the dry mix of flavoring dissolves therein and the tequila is released through the pores the alginate-based coating in the same manner as described with respect to the baked products. In this manner, a user can prepare an alcoholic beverage comprising multiple ingredients in one convenient step.

While the present disclosure describes in detail different methods of preparing an encapsulated alcohol bead as well as different methods of using the same, such are offered by way of non-limiting examples, as other versions are possible. For example, the described embodiments deal with methods for adding encapsulated alcohol beads to baked mixes, gelatin mixes and beverages, but it will be appreciated by one skilled in the art that the described methods could also be used to add encapsulated alcohol beads to any type of food product. It is anticipated that a variety of other modifications and changes will be apparent to those having ordinary skill in the art and that such modifications and changes are intended to be encompassed within the spirit and scope of the invention as defined by the following claims.

1. An encapsulated alcohol bead comprising:
a droplet of an alcohol containing beverage; and
an encapsulating coating surrounding the droplet, said coating comprising a water-insoluble, alginate-based gel having a plurality of pores and being capable of retaining the encapsulated droplet when dry, but allowing an alcohol molecule to traverse through said pores in the presence of a hypotonic solution;
wherein when the encapsulated alcohol bead is added to a hypotonic solution, the alcohol leaches through the plurality of pores in the coating and into the surrounding solution.

2. The encapsulated alcohol bead of claim 1, wherein the alcohol containing beverage is selected from the group comprising distilled liquor, champagne, liqueur, vermouth, port, beer, wine, and brandy.

3. A method of producing an encapsulated alcohol bead comprising the steps of: preparing a first solution comprising an alginate dissolved in a first volume of a first alcohol containing beverage;
preparing a second solution comprising a multivalent salt dissolved in a second volume of a second alcohol containing beverage; and
causing liquid drops of the first solution to come into contact with the second solution to form encapsulated beads comprising an alginate-based coating on the outer surface thereof and a third volume of the first alcohol containing beverage encapsulated within the coating.

4. The method of claim 3, wherein the first and second alcohols each comprise a distilled alcohol containing beverage.

5. The method of claim 3, wherein the first and second alcohols comprise the same type of alcohol containing beverage.

6. The method of claim 3, wherein the first and second alcohols each comprise a different type of alcohol containing beverage.

7. The method of claim 3 further comprising the step of removing the encapsulated alcohol beads from the second solution by using a porous member having pores smaller than the beads.

8. The method of claim 7, further comprising the steps of:
washing the encapsulated alcohol beads in a third solution comprising the first alcohol containing beverage;
removing the encapsulated alcohol beads from the third solution by using a porous member having pores smaller than the beads; and
allowing the encapsulated alcohol beads to dry on an absorbent surface.

9. The method of claim 4, wherein the encapsulated alcohol beads are removed from the second solution using a sieve.

10. The method of claim 3, wherein the step of causing the liquid drops of the first solution to come into contact with the second solution comprises spraying the first solution into the second solution.

11. The method of claim 3, wherein the step of causing the liquid drops of the first solution to come into contact with the second solution comprises expelling the liquid drops of the first solution from a rotating disk.

12. The method of claim 3, wherein the step of causing the liquid drops of the first solution to come into contact with the second solution comprises pumping liquid drops of the first solution through an orifice at such speed and volume so as to form discrete drops.

13. An edible composition comprising a dry, free flowing mixture having at least two dry mix ingredients and a plurality of encapsulated alcohol beads, each of said encapsulated alcohol beads comprising:
a droplet of an alcohol containing beverage, and
an encapsulating coating surrounding the droplet, said coating comprising a water-insoluble, alginate-based gel having a plurality of pores and being capable of retaining the encapsulated droplet when dry but allowing an alcohol molecule to traverse through said pores in the presence of a hypotonic solution,
wherein when the encapsulated alcohol bead is added to a hypotonic solution, the alcohol leaches through the plurality of pores in the alginate-based gel coating and into the surrounding solution.

14. The edible composition of claim 13, wherein the at least two dry mix ingredients comprise a baking mix.

15. The edible composition of claim 13, wherein the at least two dry mix ingredients comprise a gelatin mix.

16. The edible composition of claim 13, wherein the at least two dry mix ingredients comprise a beverage mix.

17. The edible composition of claim 14, wherein the at least two dry mix ingredients comprises by weight:
about 20% to about 60% flour;
about 20% to about 70% sugar;
about 4% to about 26% shortening; and
about 0.1% to about 8% of a chemical leavening agent.

18. The edible composition of claim 15, wherein the at least two dry mix ingredients comprise gelatin, sweetener, flavoring, and food coloring.

19. A method of making a dry culinary mix comprising the steps of:
providing an edible composition comprising about 30% to about 70% flour by weight, about 10% to about: 70% sugar by weight, and from about 4% to about 26% emulsified shortening by weight; and
dry blending the edible composition with a plurality of dry encapsulated alcohol beads, thereby providing a free-flowing ingredient composition, wherein each encapsulated alcohol bead comprises:
a droplet of an alcohol containing beverage; and
an encapsulating coating surrounding the droplet, said coating comprising a water-insoluble, alginate-based gel having a plurality of pores and being capable of retaining the encapsulated droplet when dry but allowing an alcohol molecule to traverse through said pores in the presence of a hypotonic solution;
wherein when the encapsulated alcohol bead is added to a hypotonic solution, the alcohol leaches through the plurality of pores in the alginate-based gel coating and into the surrounding solution.

20. The method of claim 19, wherein the free-flowing ingredient composition comprises encapsulated alcohol beads in an amount of less than about 15% by weight.

21. The method of claim 19, further comprising the step of dry blending the free-flowing ingredient composition with a chemical leavening agent.

22. The method of claim 19, further comprising the step of storing the free-flowing ingredient composition for a period of time prior to using the free-flowing ingredient composition to prepare of an end food product.

23. The method of claim 19, wherein the free-flowing ingredient composition is adapted to readily disperse in an aqueous medium.

24. A method of making a product containing alcohol comprising the steps of:
providing an edible composition having a moisture content of less than about 12%, the edible composition comprising flour, sugar, and flavoring;
providing a plurality of encapsulated alcohol beads, each of the encapsulated alcohol beads comprising:
a droplet of an alcohol containing beverage, and
an encapsulating coating surrounding, the droplet, said coating comprising a water-insoluble, alginate-based gel having a plurality of pores and being capable of retaining the encapsulated droplet when dry, but allowing an alcohol molecule to traverse through said pores in the presence of a hypotonic solution,
wherein when the encapsulated alcohol bead is added to a hypotonic solution, the alcohol leaches through the plurality of pores in the alginate-based gel coating and into the surrounding solution;
dry blending the edible composition with the plurality of encapsulated alcohol beads, thereby providing a free-flowing ingredient composition;
hydrating the free-flowing ingredient composition by the addition of sufficient moisture containing liquids to yield a moisture content of from about 35% to about 45% to form a dough; and
heating the dough to form the finished food product.

25. The method of claim 24, wherein the edible composition additionally comprises shortening and an emulsifier.

26. The method of claim 24, wherein the heating step comprises cooking, baking, frying, boiling, roasting and smoking.

27. A method of making a gelatin product containing alcohol comprising the steps of:
providing an edible composition having a moisture content of less than about 12%, the edible composition comprising gelatin, sugar, and flavoring;
providing a plurality of encapsulated alcohol beads, each of the encapsulated alcohol beads comprising an alcohol contained within a porous alginate-coated bead,
dry blending the edible composition with the plurality of encapsulated alcohol beads thereby providing a free-flowing ingredient composition;
hydrating the free-flowing ingredient composition by the addition of sufficient moisture containing liquids to dissolve a portion of the free-flowing ingredient composition therein; and
heating the hydrated mixture to form the finished alcoholic gelatin product.

28. The method of claim 27, wherein the steps of hydrating the free flowing ingredient composition and heating the hydrated mixture comprise adding hot liquid to the free-flowing ingredient composition.

29. A prepackaged alcoholic product comprising a dry mixture of encapsulated alcohol beads comprising an alcohol contained within a porous alginate-coated bead, wherein when the encapsulated alcohol beads are added to a beverage, the alcohol leaches into the beverage, thereby increasing the alcohol content thereof.

30. The prepackaged alcoholic product of claim 29, wherein the dry, mixture further comprises flavorings in a dry form, the flavorings adapted to readily disperse in the beverage.
